(19) United States
(12) Patent Application Publication
(10) Pub. No.: US 2025/0351881 A1
(43) Pub. Date: Nov. 20, 2025

(54) AEROSOL PROVISION DEVICE

(71) Applicant: Nicoventures Trading Limited, London (GB)

(72) Inventors: Thomas Paul BLANDINO, Cottage Grove, WI (US); Edward Joseph HALLIDAY, London (GB); William Stephen HART, Winchester Hampshire (GB); Adam ROACH, London (GB); Mitchel THORSEN, Madison, WI (US); Thomas Alexander John WOODMAN, London (GB)

(21) Appl. No.: 19/283,046

(22) Filed: Jul. 28, 2025

Related U.S. Application Data
(63) Continuation of application No. 17/593,160, filed on Sep. 10, 2021.
(60) Provisional application No. 62/816,318, filed on Mar. 11, 2019.

(51) Int. Cl. A24F 40/465; A24F 40/20; A24F 40/51; A24F 40/53; A24F 40/57; H05B 6/06; H05B 6/10; H05B 6/36

(52) U.S. Cl. CPC A24F 40/465; A24F 40/20; A24F 40/51; A24F 40/53; A24F 40/57; H05B 6/06; H05B 6/105; H05B 6/36; H05B 2213/04

(57) ABSTRACT

A heater arrangement for an aerosol provision device comprises a susceptor arranged to heat aerosol generating material, wherein the susceptor is heatable by penetration with a varying magnetic field, a first wire connected to the susceptor at a first position, a second wire connected to the susceptor at a second position, wherein the second position is spaced apart from the first position, and electronic circuitry configured to determine a temperature of the susceptor at the first position based on a potential difference measured between the first wire and the second wire.

### PRIORITY CLAIM

The present application is a continuation of U.S. application Ser. No. 17/593,160, filed on Sep. 10, 2021, which is a National Phase entry of PCT Application No. PCT/EP2020/056244, filed Mar. 9, 2020, which claims priority from U.S. Provisional Application No. 62/816,318, filed Mar. 11, 2019, each of which is hereby fully incorporated herein by reference.

### TECHNICAL FIELD

The present invention relates to a heater arrangement of an aerosol provision device and an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a heater arrangement for an aerosol provision device. The heater arrangement includes a heater component arranged to heat aerosol generating material; a first wire connected to the heater component at a first position; a second wire connected to the heater component at a second position, wherein the second position is spaced apart from the first position; and electronic circuitry configured to: determine a temperature of the heater component at the first position based on a potential difference measured between the first wire and the second wire.

According to a second aspect of the present disclosure, there is provided an aerosol provision device. The device includes a heater arrangement according to the first aspect and an inductor coil for generating a varying magnetic field.

According to another of the present disclosure, there is provided a heater arrangement for an aerosol provision device. The heater arrangement includes a susceptor arranged to heat aerosol generating material, wherein the susceptor is heatable by penetration with a varying magnetic field; a first wire connected to the susceptor at a first position; a second wire connected to the susceptor at a second position, wherein the second position is spaced apart from the first position; and electronic circuitry. The electronic circuitry is configured to determine a temperature of the susceptor at the first position based on a potential difference measured between the first wire and the second wire.

According to another aspect of the present disclosure, there is provided a heater arrangement for an aerosol provision device. The heater arrangement includes a heater component arranged to heat aerosol generating material; a first wire connected to the heater component at a first position; wherein, at the first position, where the first wire is connected to the heater component, the first wire is covered by a protective coating.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a front view of the aerosol provision device of FIG. 1 with an outer cover removed;

FIG. 3 shows a cross-sectional view of the aerosol provision device of FIG. 1;

FIG. 4 shows an exploded view of the aerosol provision device of FIG. 2;

FIG. 5A shows a cross-sectional view of a heating assembly within an aerosol provision device;

FIG. 5B shows a close-up view of a portion of the heating assembly of FIG. 5A;

FIG. 6 shows first and second inductor coils wrapped around an insulating member;

FIG. 7 shows a diagrammatic representation of a standard thermocouple;

FIG. 8 shows a diagrammatic representation of a susceptor and two standard thermocouples according to an example;

FIG. 9 shows a diagrammatic representation of a susceptor and two thermocouples according to another example;

FIG. 10 shows a further diagrammatic representation of the susceptor of FIG. 9; and

FIG. 11 shows a further diagrammatic representation of the susceptor of FIG. 9.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatuses are known that heat aerosol generating material to volatilize at least one component of the aerosol generating material, typically to form an aerosol which can be inhaled, without burning or combusting the aerosol generating material. Such apparatuses are sometimes described as an “aerosol generating device,” an “aerosol provision device,” a “heat-not-burn device,” a “tobacco heating product device,” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines a heater component arranged to heat aerosol generating material. In certain examples, the heater component is a susceptor. As will be discussed in more detail herein, a susceptor is an electrically conducting object, which is heated via electromagnetic induction. The susceptor is therefore heatable by penetration with a varying magnetic field. An article comprising aerosol generating material can be received within the susceptor. Once heated, the susceptor transfers heat to the aerosol generating material, which releases the aerosol.

In the present example, the aerosol provision device can monitor the temperature of the heater component in one or more locations, as it is being heated. This can be useful to ensure that the aerosol generating material is heated to the correct temperature. For example, if the temperature of the heater component is too high, the aerosol generating material may overheat, which can impact the taste/flavor of the aerosol. If the temperature of the heater component is too low, the volume of aerosol generated may be too low. Accordingly, it may be useful to monitor and control the temperature of the heater component during heating.

To monitor the temperature of the heater component in one or more regions, one or more temperature sensors may be in contact with the heater component. The temperature sensors may be thermocouples, for example. As will be well understood, a thermocouple is a device used for sensing temperature which comprises two dissimilar electrical conductors/wires. Typically, the two wires are joined together at one end to form a “measurement junction” while a second end of the wires may form a “reference junction.” According to the Seebeck effect a voltage is generated between the wires which is dependent on a temperature difference between the measurement junction and the reference junction. If the temperature of the reference junction is known, then the temperature at the measurement junction can be determined from the potential difference measured between the wires. Electronic circuitry, such as a controller and a voltmeter, can infer the temperature based on the measured potential difference.

In the first aspect, a thermocouple is provided by the use of a first wire and a second wire. The first wire is connected to the heater component at a first position, and the second wire is connected to the heater component at a second position. The first wire and the second wire must be dissimilar so as to function as a thermocouple. Rather than joining the two wires together at the first position to form a measurement junction, the heater component can act as an extension of the second wire between the second and first positions. The temperature measured by the electronic circuitry of the device is therefore the temperature at the first position. This temperature is determined based on the potential difference measured between the first and second wires. The first wire and the heater component therefore form the measurement junction at the first position, rather than the first wire and the second wire.

Because the heater component acts as an extension of the second wire, it means that the second wire does not need to be connected to the first wire at the first position. Allowing the second wire to be connected anywhere along the heater component allows more freedom in the construction of the device. For example, a shorter second wire can be used, rather than routing a longer wire through the device to connect it to the first wire.

The heater component can form a true extension of the second wire if the heater component is made from a material that is “similar” to that of the second wire. Similar materials, in this context, are materials which behave in a similar way when the same temperature difference is present between two points along the materials. In other words, the voltage created along the two materials is the same, or substantially the same when the same temperature difference is present between two points. Since the temperature is estimated based on the measured potential difference, the degree of similarity between the materials will determine how accurate the temperature measurement is. For example, if the second wire and heater component are made from exactly the same material, they will behave in the same way when a temperature gradient is applied to them. Thus, in theory, the arrangement will be indistinguishable from a standard thermocouple when the second wire is directly connected to the first wire. If the heater component and second wire have different compositions, the temperature estimated by the electronic circuitry may differ from that measured by a standard thermocouple. Thus, the degree of similarity between the heater component and second wire affects how accurate the measured temperature is. The degree of similarity is therefore dependent upon how accurate the temperature measurements are required to be. If a user requires an extremely accurate temperature measurement, the second wire and heater component should be made from a very similar material, whereas if the user only requires a rough estimate of the temperature, the heater component and second wire can be less similar. By varying the materials of the heater component or second wire, a user can determine a measurement error by comparing the estimated temperature to that of a standard thermocouple.

Two materials which create the same, or similar voltage when the same temperature difference is present between two points may be said to have substantially the same (intrinsic) Seebeck coefficient. Thus, the effective Seebeck coefficient of the first wire, and the combined second wire and heater component should be substantially the same as the effective Seebeck coefficient of the first wire and the second wire. Materials with a similar Seebeck coefficient will therefore provide a more accurate estimation of temperature.

Generally, materials with the same or similar composition will have substantially the same Seebeck coefficient. Accordingly, in some examples, the heater component and the second wire may comprise substantially the same metal or alloy (i.e., they both have substantially the same composition). The first wire has a different composition to the heater component and the second wire. For example, the first wire has a different Seebeck coefficient to the heater component and second wire.

For example, the heater component may comprise at least 95 wt % of a particular metal or alloy, and the second wire may comprise at least 95 wt % of the same metal or alloy. Preferably, the heater component may comprise at least 97 wt % of a particular metal or alloy, and the second wire may comprise at least 97 wt % of the same metal or alloy. More preferably the heater component may comprise at least 99 wt % of a particular metal or alloy, and the second wire may comprise at least 99 wt % of the same metal or alloy. It has been found that materials which comprise substantially the same metal or alloy provide more accurate temperature measurements.

In a particular example, the heater component and the second wire each comprise at least 95 wt % Iron. Preferably the heater component and the second wire each comprise at least 96 wt % Iron, or the heater component and the second wire each comprise at least 97 wt % Iron, or the heater component and the second wire each comprise at least 98 wt % Iron. More preferably the heater component and the second wire each comprise at least 99 wt % Iron. It has been found that materials which comprise substantially the same wt % Iron provide more accurate temperature measurements.

In a further example, the heater component comprises steel comprising 99.18 to 99.62 wt % Iron, and the second wire comprises at least 99 wt % Iron. Steel with 99.18-99.62 wt % Iron may be known as AISI 1010 carbon steel (as defined by the American Iron and Steel Institute). More preferably, the second wire may comprise at least 99.5 wt % Iron, such as 99.6 wt % Iron. It has been found that such materials provide accurate temperature measurements within about ±5° C.

The first wire may be made from a copper-nickel alloy. The copper-nickel alloy may be an alloy comprising approximately 55 wt % copper and 45 wt % nickel, such as that sold under the trade name Constantan™. Thus, the second wire may comprise iron, and the first wire comprise a copper-nickel alloy, such as Constantan. A thermocouple comprising an iron wire and a copper-nickel wire is more commonly known as a type-J thermocouple. The first wire, second wire, heater component and electronic circuitry therefore form a type-J thermocouple.

In some examples, it may be desirable to measure the temperature of the heater component in two or more regions/zones. For example, a first thermocouple arrangement may measure the temperature of the heater component at a first position in a first region/zone (as described above), and a further, second, thermocouple arrangement may measure the temperature of the heater component at a third position in a second region/zone. The first zone may be heated by a first inductor coil and the second zone may be heated by a second inductor coil, for example.

Accordingly, the heater arrangement may further comprise a third wire connected to the heater component at a third position, wherein the third position is spaced apart from the first position and the second position. The electronic circuitry may be further configured to determine a second temperature of the heater component at the third position based on a second potential difference measured between the third wire and the second wire.

The third wire, and the combined second wire and heater component therefore act as part of a second thermocouple where the potential difference is now measured between the second wire and the third wire to obtain the temperature at the third position. Thus, two thermocouples can be constructed by use of only three wires, rather than four wires that would normally be needed for two thermocouples. Similarly, three thermocouples can be constructed by use of four wires, and four thermocouples can be constructed by use of five wires. Thus, each thermocouple shares a common wire (the second wire). The heater component therefore also forms an extension of the second wire between the second and third positions. Thus, to measure the temperature at the first position, the potential difference can be measured between the first wire and the second wire, and to measure the temperature at the third position, the potential difference can be measured between the third wire and the second wire. This arrangement enables the second wire to be used as part of a first thermocouple and as part of a second thermocouple, which reduces the complexity of the device. By using one less wire, the weight and cost of the device can be reduced.

The third wire may have a composition that is at least one of: (i) different to the composition of the heater component and the second wire, and (ii) the same as the composition of the first wire. For example, in (i) the third wire must be made from a different metal/alloy to the heater component and second wire to function as a thermocouple. In (ii), the third wire may be substantially the same as the first wire and so may also be made from a copper-nickel alloy. This may simplify the process of estimating the temperature by the electronic circuitry. For example, the same algorithm can be used to estimate the temperature in this second thermocouple arrangement as to that used in the first thermocouple arrangement because the materials are the same.

The first position may be closer to a first end of the heater component than the second position, and the second position may be closer to the first end of the heater component than the third position. Thus, the second position may be located between the first and third positions. This reduces the length over which the heater component acts as an extension of the second wire, which can result in a more accurate temperature estimate for the first and third positions. The first end of the heater component may be a proximal/mouth end of the heater component.

In a specific arrangement, the heater component is surrounded by two inductor coils. The first inductor coil is wrapped around the heater component in a first region/zone and the second inductor coil is wrapped around the heater component in a second region/zone. The first position may be located at a midpoint in the first region/zone, and the third position may be located at a midpoint in the second region/zone. In some examples the first inductor coil and zone is shorter than the second inductor coil and zone. For example, the first inductor coil may have a length of between about 15 mm and about 20 mm, and the second inductor coil may have a length of between about 25 mm and about 30 mm. The heater component may therefore have a length of between about 40 mm and about 50 mm. In a specific example, the first inductor coil is arranged towards a mouth/proximal end of the heater component (i.e., an end which is closer to the user's mouth when the device is being used), and the second inductor coil is arranged towards a distal end of the heater component. In a more specific example, the first position may be located around 32-36 mm from the distal end of the heater component, and the third position may be located around 12-16 mm from the distal end of the heater component.

Preferably, the second position is located on the heater component at a midpoint between the first position and the third position. This means that the distance between the first and second position is substantially equal to the distance between the second and third positions. This means that the distance over which the heater component acts as an extension of the second wire is minimized for both thermocouple arrangements. Reducing this distance can improve the accuracy of the temperature estimation. In examples where the first and second inductor coils are controlled based on the measured temperatures, a more accurate temperature estimate can result in a more accurate control of the inductor coils. When the inductor coils are operated more accurately, it can stop the aerosol generating material from overheating (by ensuring the zones do not get too hot) and can ensure that the aerosol generating material not underheated (by ensuring the zones are heated to the correct temperature). More accurate control over the inductor coils can make the device more energy efficient.

In another example, the second and third positions are located at substantially the same distance along the heater component (they may be located at different points around the perimeter of the heater component). The distance is measured from an end of the heater component. In another example, the third position (and first position) is further along the heater component than the second position. Both arrangements allow the length of the second wire to be reduced, which can reduce the mass of the device, as well as the cost.

Preferably, the first, second and third wires are separate and not joined together along their length.

In some examples, at the first position, where the first wire is connected to the heater component, the first wire is covered by a protective coating. Additionally, or alternatively, at the second position, where the second wire is connected to the heater component, the second wire is covered by a protective coating. Additionally, or alternatively, at the third position, where the third wire is connected to the heater component, the third wire is covered by a protective coating.

The protective coating can help reduce or stop corrosion of the wire, or the material joining the wire to the heater component, at the point at which the wire is connected to the heater component. Corrosion, such as acidic or galvanic corrosion, may occur if the aerosol or condensed aerosol comes into contact with exposed parts of wire. Wire with a high iron content may be particularly vulnerable to corrosion. The protective coating can therefore act as a barrier, by stopping the aerosol from coming into contact with the wire.

In some examples, the protective coating covers only a portion of the wire(s). For example, the coating may only cover the exposed electrically conductive part of the wire. The coating may only be present in the vicinity of the boundary/connection point of the wire to the heater component.

In examples where the wire comprises an electrically insulating “jacket,” the protective coating is distinct from the jacket.

In one particular arrangement, the protective coating comprises a metal or a metal alloy. For example, during manufacture, the wire can firstly be connected to the heater component, and secondly be coated in a metal or metal alloy. Thus, the coating is applied after the wire has been connected to the heater component. The coating may, for example, cover/coat the entire heater component, or at least a portion of the outer surface of the heater component in the vicinity of the connection point between the wire and heater component.

The protective coating may comprise nickel. Nickel, for example, has good anti-corrosion properties. Furthermore, nickel is also ferromagnetic, and thus generates additional heat through magnetic hysteresis, which is particularly useful in aerosol provision devices.

In one example, the metal or metal alloy coating has a thickness of up to 15 microns, such as between about 1 micron and about 15 microns. In a particular example, the metal or metal alloy coating has a thickness of between about 1.5 and about 2.5 microns.

In another arrangement, the protective coating comprises a sealant. The sealant can be applied after the wire has been connected to the heater component. The sealant again acts as a barrier and stops the aerosol from coming into contact with the wire. The sealant may be moisture and water resistant.

Preferably the sealant is a high-temperature sealant. That is, the sealant is heat resistant. A heat resistant sealant may mean that the sealant has a high melting point. In an aerosol provision device, where the heater component is heated to between about 200° C. and about 300° C., the sealant should be able to withstand temperatures of up to around 300° C. or up to around 350° C., for example.

In some examples, the sealant is a silicone-based sealant. In some examples, the sealant is an alumina-based adhesive.

The sealant may be Cramolin Isotemp™, Korthals, Aremco Ceramabond™ Glassbond™/Saureisen™ product No. 3, a Masterbond™ high temperature bonding, sealing, and coating compound, or a Pi-Kem™ high temperature ceramic adhesive, for example. In some examples, the sealant is electrically insulating.

In one example there is provided a thermocouple for an aerosol provision device comprising a first wire and a second wire, wherein a first end of the first wire, and a first end of the second wire form a measurement junction, and wherein the first end of the first wire is not connected (or joined) to the first end of the second wire. Accordingly, the first end of the first wire and the first end of the second wire can be connected to an electrically conductive object (such as a susceptor) which has a similar composition to one of the first or second wires. Accordingly, the thermocouple can function without needing the ends of the two wires to be connected. A second end of the first wire, and a second end of the second wire form a reference junction. The thermocouple can comprise any of the features described above.

In another aspect, there is provided a heater arrangement for an aerosol provision device. The heater arrangement comprises a heater component arranged to heat aerosol generating material, a first wire connected to the heater component at a first position, wherein, at the first position, where the first wire is connected to the heater component, the first wire is covered by a protective coating. The protective coating may comprise any or all of the features described above.

In some examples, the heater arrangement further comprises a second wire connected to the heater component at the first position. The first and second wires may therefore be connected to each other at the first position.

In other examples, the second wire is connected to the heater component at a second position, wherein the second position is spaced apart from the first position. Thus, in these examples, the heater component may form an extension of the first wire.

In examples comprising multiple wires connected to the heater component, the protective coating may be the same at each wire connection point, or may be different. In some examples, only some wires are coated with a protective coating.

As briefly mentioned above, in some examples, coil(s) is/are configured to, in use, cause heating of at least one electrically-conductive heating component/element (also known as a heater component/element), so that heat energy is conductible from the at least one electrically-conductive heating component to aerosol generating material to thereby cause heating of the aerosol generating material.

In some examples, the coil(s) is/are configured to generate, in use, a varying magnetic field for penetrating at least one heating component/element, to thereby cause induction heating and/or magnetic hysteresis heating of the at least one heating component. In such an arrangement, the or each heating component may be termed a “susceptor.” A coil that is configured to generate, in use, a varying magnetic field for penetrating at least one electrically-conductive heating component, to thereby cause induction heating of the at least one electrically-conductive heating component, may be termed an “induction coil” or “inductor coil.”

The device may include the heating component(s), for example electrically-conductive heating component(s), and the heating component(s) may be suitably located or locatable relative to the coil(s) to enable such heating of the heating component(s). The heating component(s) may be in a fixed position relative to the coil(s). Alternatively, both the device and such an article may comprise at least one respective heating component, for example at least one electrically-conductive heating component, and the coil(s) may be to cause heating of the heating component(s) of each of the device and the article when the article is in the heating zone.

In some examples, the coil(s) is/are helical. In some examples, the coil(s) encircles at least a part of a heating zone of the device that is configured to receive aerosol generating material. In some examples, the coil(s) is/are helical coil(s) that encircles at least a part of the heating zone. The heating zone may be a receptacle, shaped to receive the aerosol generating material.

In some examples, the device comprises an electrically-conductive heating component that at least partially surrounds the heating zone, and the coil(s) is/are helical coil(s) that encircles at least a part of the electrically-conductive heating component. In some examples, the electrically-conductive heating component is tubular. In some examples, the coil is an inductor coil.

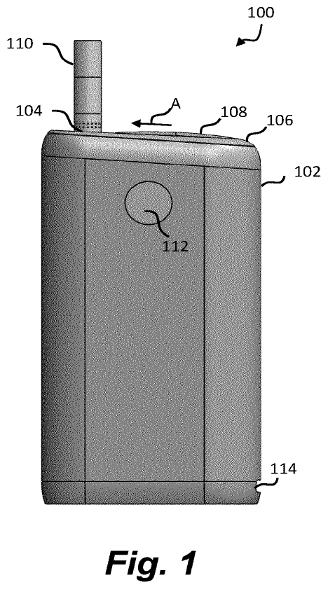

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

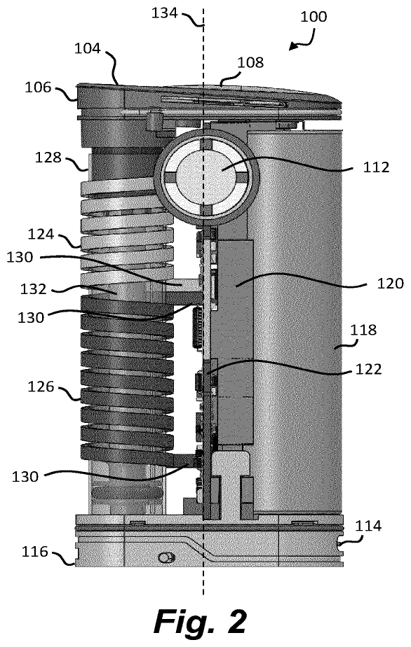

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e., by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section of the article 110, and at a later time, the second inductor coil 126 may be operating to heat a second section of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

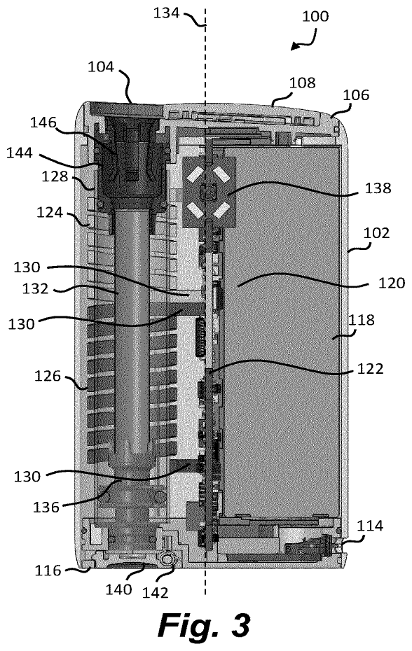

FIG. 3 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

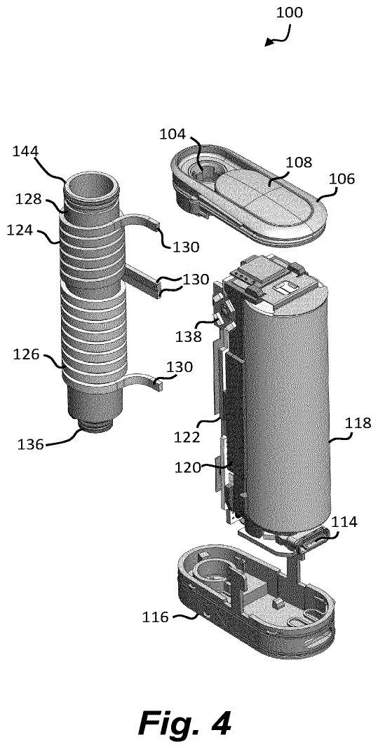

FIG. 4 is an exploded view of the device 100 of FIG. 1, with the outer cover 102 omitted.

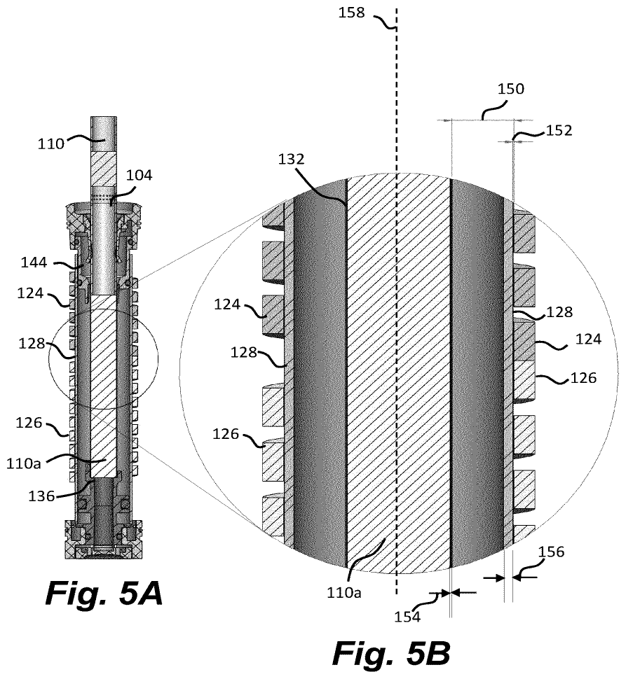

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially Omm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

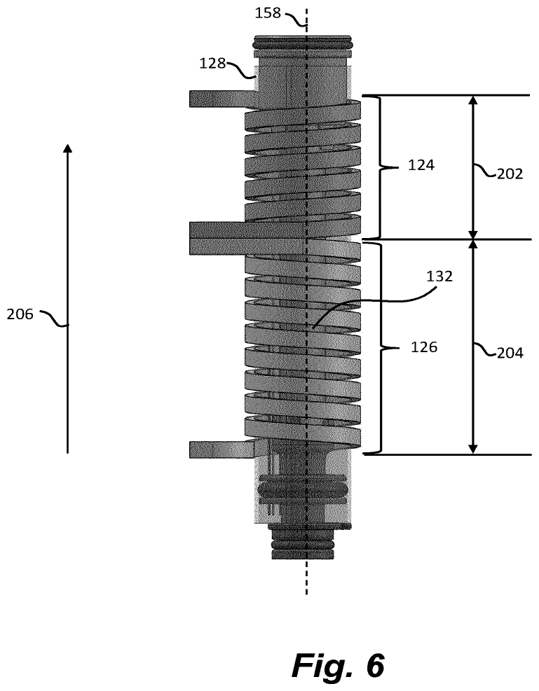

FIG. 6 depicts the heating assembly of the device 100. As briefly mentioned above, the heating assembly comprises a first inductor coil 124 and a second inductor coil 126 arranged adjacent to each other, in the direction along the axis 158 (which is also parallel to the longitudinal axis 134 of the device 100). In use, the first inductor coil 124 is operated initially. This causes a first region/zone of the susceptor 132 to heat up (i.e. the section of the susceptor 132 surrounded by the first inductor coil 124), which in turn heats a first portion of the aerosol generating material. At a later time, the first inductor coil 124 may be switched off, and the second inductor coil 126 may be operated. This causes a second region/zone of the susceptor 132 to heat up (i.e. the section of the susceptor 132 surrounded by the second inductor coil 126), which in turn heats a second portion of the aerosol generating material. The second inductor coil 126 may be switched on while the first inductor coil 124 is being operated, and the first inductor coil 124 may switch off while the second inductor coil 126 continues to operate. Alternatively, the first inductor coil 124 may be switched off before the second inductor coil 126 is switched on. Electronic circuitry, including a controller, can control when each inductor coil is operated/energized. The inductor coils can be operated based on the temperature of the susceptor 132, to ensure that each zone is heated to the correct temperature at the correct time.

In some examples, the length 202 of the first inductor coil 124 is shorter than the length 204 of the second inductor coil 126. The length of each inductor coil is measured in a direction parallel to the axis of susceptor 158, which is also parallel to the axis of the device 134. The first, shorter inductor coil 124 is arranged closer to the mouth end (proximal end) of the device 100 than the second inductor coil 126. When the aerosol generating material is heated, aerosol is released. When a user inhales, the aerosol is drawn towards the mouth end of the device 100, in the direction of arrow 206. The aerosol exits the device 100 via the opening/mouthpiece 104, and is inhaled by the user. The first inductor coil 124 is arranged closer to the opening 104 than the second inductor coil 126.

In this example, the first inductor coil 124 has a length 202 of about 20 mm, and the second inductor coil 126 has a length 204 of about 30 mm. A first wire, which forms the first inductor coil 124, is helically wound around the insulating member 128. Similarly, a second wire is helically wound to form the second inductor coil 126. Although the first and second wires are depicted with a rectangular cross section, they may have a different shape cross section, such as a circular cross section.

In examples, the device 100 comprises one or more temperature sensors for sensing a temperature of the susceptor 132. For example, one temperature sensor may be provided for each zone of the susceptor 132. As described above, the susceptor 132 comprises a first zone and a second zone, and electronic circuitry (which may include a controller) operates the inductor coils 124, 126 as necessary. In the present device, the temperature sensors used to measure the temperature of the susceptor 132 are thermocouples. A temperature sensor may be located at, or near, a midpoint of a zone, for example.

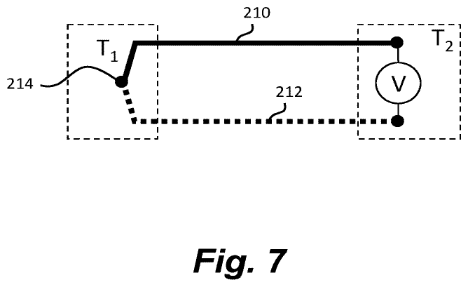

FIG. 7 depicts a diagram of an example thermocouple, which may be used to measure the temperature of the susceptor 132 at one or more locations. The thermocouple comprises two conductors 210, 212, which are connected at one end to form a measurement junction 214 which is at a temperature T₁, and the other ends of the conductors 210, 212 are held at a second, known temperature T₂. The two conductors 210, 212 are made from dissimilar materials. For example, the first conductor 210 is made from Iron, and the second conductor 212 is made from a copper-nickel alloy, such as Constantan. Thus, the thermocouple is a J-type thermocouple. In other examples, different types of thermocouples comprising different pairs of dissimilar conductors may be used, such as type E, K, M thermocouples for example.

When T₁ and T₂ are different, each conductor 210, 212 produces a voltage as a result of the Seebeck effect. The voltage produced by the first conductor 210 is V₁=S₁ΔT, and the voltage produced by the second conductor 212 is V₂=S₂ΔT, where S₁ and S₂ are the respective Seebeck coefficients of the first and second conductors 212, 212 and ΔT=T₂−T₁. The voltmeter V will therefore measure a potential difference between the two conductors 210, 212 given by V=V₁−V₂=S₁ΔT−S₂ΔT=S_{1,2}ΔT. S_{1,2}=S₁−S₂ is the effective Seebeck coefficient of the conductor pair. While S₁ and S₂ are intrinsic material properties of the conductors themselves, S_{1,2} is an effective Seebeck coefficient that describes the thermoelectric performance of the thermocouple. The thermocouple can be calibrated based on known temperatures, which can determine the effective Seebeck coefficient when V is measured. Thus, T₁ can be determined by measuring the voltage V, if T₂ and S_{1,2} are known. T₂ may be held at room temperature, for example.

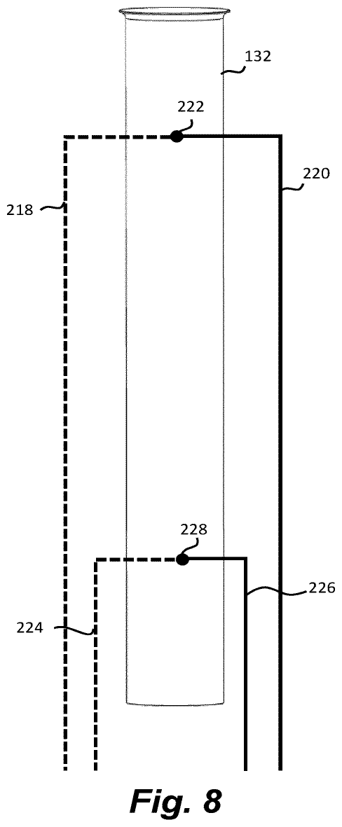

FIG. 8 is a diagrammatic representation of a susceptor 132 comprising two “standard” thermocouples which can be used to measure the temperature of the susceptor at two positions. The reference junction of each thermocouple is not shown in FIG. 8. The reference junction may be a thermistor that is located on the PCB 122, for example.

Connected to the susceptor 132 at a first position 222 is a first conductor 218 and a second conductor 220. The first conductor 218 and the second conductor 220 form part of a first thermocouple which measure the temperature of the susceptor 132 in a first zone at the first position 222. Connected to the susceptor 132 at a second position 228 is a third conductor 224 and a fourth conductor 226. The third conductor 224 and the fourth conductor 226 form part of a second thermocouple which measure the temperature of the susceptor 132 in a second zone at the second position 228. Based on the measured voltage between the first and second conductors 218, 220 the temperature at the first position 222 can be determined. Similarly, based on the measured voltage between the third and fourth conductors 224, 226 a second temperature at the second position 228 can be determined.

In the example heater arrangement of FIG. 8, each thermocouple comprises two wires/conductors which are connected together at a measurement junction. However, it has been found that for each thermocouple, the two conductors do not need to be connected together if the susceptor 132 is made from a material that is “similar” to one of the conductors. The two wires of a thermocouple can instead be connected to the susceptor at different locations. The susceptor 132 therefore forms an extension of one of the wires/conductors. The conductor which is dissimilar to the susceptor is connected at a position where the temperature is to be measured. The conductor which is similar to the susceptor can be connected anywhere on the susceptor. Allowing one of the conductors/wires be connected anywhere along the susceptor allows more freedom in the construction of the device.

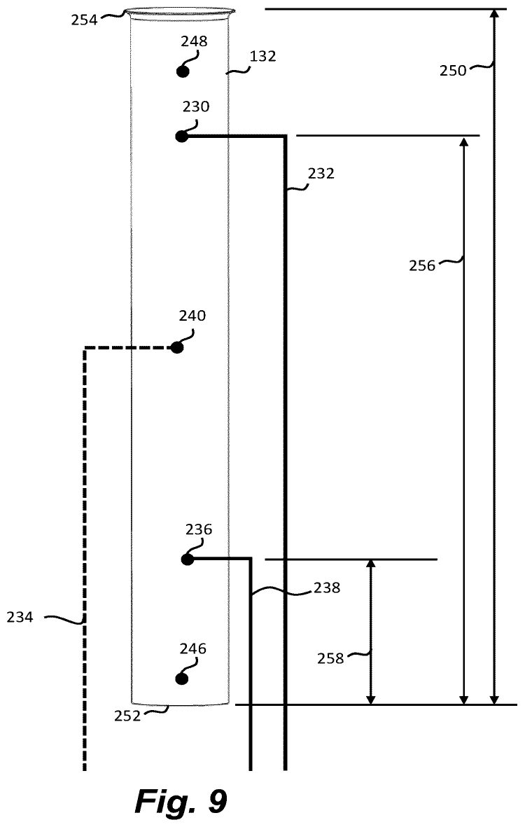

FIG. 9 therefore depicts an alternative heater arrangement to the one depicted in FIG. 8. In this arrangement, a first conductor/wire 232 is connected to the susceptor 132 at a first position 230. A second conductor/wire 234 is connected to the susceptor 132 at a second position 240. The first and second positions 230, 240 are therefore spaced apart along the susceptor. In this example, the second wire 234 is made of a similar material to the susceptor 132, such that the susceptor 132 forms an extension of the second wire 234. The first wire 232 is dissimilar to the susceptor 132 and second wire 234. The measurement junction is the boundary between dissimilar materials, so the measurement junction is located at the first position 230. The first wire 232, second wire 234 and susceptor 132 therefore form part of a first thermocouple which measure the temperature of the susceptor 132 in a first zone at the first position 230. The temperature can be determined based on a potential difference measured between the first wire 232 and the second wire 234.

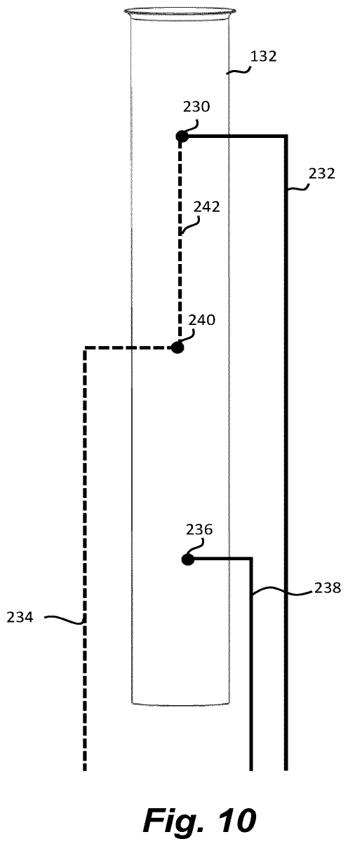

If the susceptor 132 and second wire 234 are of a similar material (i.e. they have a similar intrinsic Seebeck coefficient), the effective Seebeck coefficient of the thermocouple is similar to the effective Seebeck coefficient of the thermocouple if the first and second wires 232, 234 were to be arranged like that shown in FIG. 8. For example, if the susceptor 132 is made from substantially the same metal or alloy as the second wire 234, the susceptor 132 and second wire 234 are likely to have similar intrinsic Seebeck coefficients, and therefore will create the same voltage when a temperature gradient is present. In this example, the first wire 232 is made from a copper-nickel alloy, such as Constantan, the susceptor 132 is made from carbon steel comprising between about 99.18 wt % and 99.62 wt % Iron, and the second wire 234 comprises about 99.6 wt % Iron. The susceptor 132 and second wire 234 therefore have a similar composition such that the susceptor 132 forms an extension of the second wire 234 between the first position 230 and the second position 240. FIG. 10 depicts a path 242 along the susceptor 132 between the first position 230 and the second position 240. The algorithm described in relation to FIG. 7 is therefore a good approximation of the arrangement in FIGS. 9 and 10 because the path 242 along the susceptor behaves in substantially the same way as would a length of the second wire 234.

If it is required to measure the temperature of the susceptor 132 at another position (such as at a third position 236) a third conductor/wire 238 can be connected to the susceptor 132 at the third position 236. The third wire 238 may have the same or a different composition as the first wire 232. As with the first thermocouple, a dissimilar conductor/wire need not be directly connected to the third wire 238 at the third position 236. Instead, the second wire 234 can also form part of this second thermocouple even though it is connected to the susceptor 132 at the second position 240. Again, this is because the susceptor 132 is made from a material that is “similar” to the second wire 234. The susceptor 132 therefore forms an extension of the second wire 234 between the second position 240 and the third position 236. In this example, the third wire 238 is dissimilar to the susceptor 132, meaning that the measurement junction is located at the third position 236. The third wire 238, the second wire 234 and susceptor 132 therefore form part of a second thermocouple which measure the temperature of the susceptor 132 in a second zone at the third position 236. This temperature is determined based on a potential difference measured between the third wire 238 and the second wire 234.

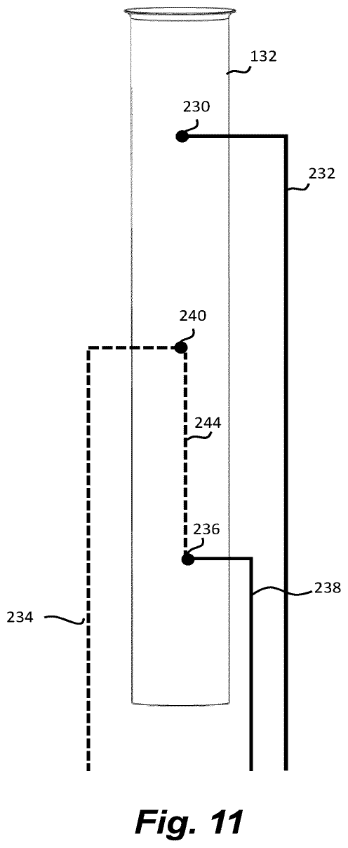

In this example, the third wire 238 is made from a copper-nickel alloy, such as Constantan, and is substantially the same as the first wire 232. Because the susceptor 132 and second wire 234 have a similar composition, the susceptor 132 forms an extension of the second wire 234 between the second position 240 and the third position 236. FIG. 11 depicts a path 244 along the susceptor 132 between the third position 236 and the second position 240. The algorithm described in relation to FIG. 7 is therefore a good approximation of the arrangement in FIGS. 9 and 11 because the path 244 along the susceptor behaves in substantially the same way as would a length of the second wire 234.

Returning to FIG. 9, the first position 230 is located in a first zone on the susceptor 132, where the first zone is defined as a region which is located beneath the first inductor coil 124 which surrounds the susceptor 132. Preferably the first position 230 is located towards the midpoint of the first zone. Similarly, the third position 236 is located in a second zone on the susceptor 132, where the second zone is defined as a region which is located beneath the second inductor coil 126 which surrounds the susceptor 132. Preferably the third position 236 is located towards the midpoint of the second zone.

In an example, the susceptor 132 has a length 250 of about 44 mm measured between its distal end 252 and its proximal end 252. The first position 230 may be located at about 35 mm away from the distal end 252 of the susceptor 132, and the third position 236 may be located at about 14 mm away from the distal end 252. The distance between the distal end 252 and the first position 230 is indicated by distance 256, and the distance between the distal end 252 and the third position 236 is indicated by distance 258. Distances 256, 258 are measured parallel to the longitudinal axis 158 of the susceptor 132.

In a particular example, the first inductor coil 124 has a length of between about 15 mm and about 20 mm, such as about 19 mm, and the second inductor coil 126 has a length of between about 25 mm and about 30 mm, such as about 28 mm. The first and second inductor coils 124, 126 may therefore extend beyond the ends 252, 254 of the susceptor 132.

In the examples of FIGS. 9-11, the second wire 234 is connected to the susceptor 132 at the second position 240 which is located between the first and third positions 230, 236. Preferably, the second position 240 is located at the midpoint between the first and third positions 230, 236 so that the paths 242, 244 are substantially equal in length. This is desirable to ensure that the temperatures estimated at the first and third positions 230, 236 have the same uncertainty. The temperature estimations may have an element of uncertainty because it is assumed that the susceptor 132 behaves in the same way as the second wire 234 which depends upon the difference in composition (and therefore intrinsic Seebeck coefficients) between the susceptor and second wire 234.

If the second wire 234 was instead connected to the susceptor 132 at a fourth position 248 (see FIG. 9), the path length between the fourth position 248 and the first position 230 would be much shorter than the path length between the fourth position 248 and the third position 236. This could mean that the temperature estimated at the first position 230 is more reliable than the temperature estimated at the third position 236. Similarly, if the second wire 234 was instead connected to the susceptor 132 at a fifth position 246 (see FIG. 9), the path length between the fifth position 246 and the first position 230 would much longer than the path length between the fifth position 246 and the third position 236. This could mean that the temperature estimated at the first position 230 is less reliable than the temperature estimated at the third position 236.

In some example devices, positioning the second wire at a midpoint between the first and third positions can lead to a more accurate estimation of the temperatures to the extent that the first and second inductor coils can be operated/controlled more efficiently. In a particular test, it was found that the device can use up to 3% less energy when located at position 240 when compared to positions 248, 246.

However, it will be appreciated that the uncertainty in the temperature estimations may be negligible depending upon the materials and compositions of the susceptor 132 and second wire 232 to the extent that the second wire 232 can be connected anywhere on the susceptor 132.

In the above examples, the conductors/wires can be connected to the susceptor via various methods, such as via spot welding for example. The conductors/wires may be located at the same, or different positions around the outer circumference of the susceptor. Preferably the first, second and third conductors/wires are located at the same position around the outer circumference to minimize the path length between the first and second, and first and third positions.

As mentioned, in some examples of the arrangement of FIG. 8, the first and second thermocouples are J-type thermocouples. For example, the first and third conductors 218, 224 are made from Iron, and the second and fourth conductors 220, 226 are made from a copper-nickel alloy, such as Constantan. While the arrangement of FIG. 8 does require the use of four wires, it can provide a useful alternative arrangement to that in FIG. 9 because it provides redundancy should the first conductor 218 or the third conductor 224 disconnect (due to corrosion, for example) from the susceptor 132. For example, if the first conductor 218 disconnects from the susceptor 132, the temperature of the susceptor can still be measured at the first position 222 using the second conductor 220 and the third conductor 224 because a section of the susceptor 132 between the first and second positions 222, 228 forms an extension of the third conductor 224. Similarly, if the third conductor 224 disconnects from the susceptor 132, the temperature of the susceptor can still be measured at the second position 228 using the first conductor 218 and the fourth conductor 226 because a section of the susceptor 132 between the first and second positions 222, 228 forms an extension of the first conductor 218.

The arrangement of FIG. 8 can therefore act in a similar way to that described in FIGS. 9-11 when one of the conductors disconnects. Thus, in some examples, electronic circuitry in the device (such as a controller) is configured to: (i) determine that the first conductor 218 has disconnected from the heater component, and (ii) responsively determine a temperature of the heater component 132 at the first position 222 based on a potential difference measured between the third conductor 224 and the second conductor 220. Similarly, electronic circuitry in the device (such as a controller) is configured to: (i) determine that the third conductor 224 has disconnected from the heater component, and (ii) responsively determine a temperature of the heater component 132 at the second position 228 based on a potential difference measured between the first conductor 218 and the fourth conductor 226. The electronic circuitry may determine that the first conductor 218 has disconnected if the potential difference measured between the first conductor 218 and the second conductor 220 is not within an expected range, for example. Similarly, the electronic circuitry may determine that the third conductor 224 has disconnected if the potential difference measured between the third conductor 224 and the fourth conductor 226 is not within an expected range, for example.

In any of the above described examples, such as those described in FIGS. 8-11, any or all of the connection points (i.e. the positions at which the wires connect to the susceptor 132) may comprise a protective coating. The protective coating covers the conductor at the point at which it connects to the susceptor 132 and can protect the wire from corrosion. The protective coating may comprise a layer of a metal or metal alloy, for example, such as nickel. In other examples, the coating may comprise a sealant. This can reduce the likelihood of the conductor disconnecting from the susceptor 132.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A heater arrangement for an aerosol provision device, the heater comprising:
a heater component arranged to heat aerosol generating material;
a first wire connected to the heater component at a first position;
a second wire connected to the heater component at a second position, wherein the second position is spaced apart from the first position; and
electronic circuitry configured to:
determine a temperature of the heater component at the first position based on a potential difference measured between the first wire and the second wire.

2. A heater arrangement according to claim 1, wherein the heater component and the second wire have substantially the same Seebeck coefficient.

3. A heater arrangement according to claim 1, wherein the heater component and the second wire comprise substantially the same metal or alloy.

4. A heater arrangement according to claim 1, wherein the heater component and the second wire each comprise at least 95 wt % Iron.

5. A heater arrangement according to claim 4, wherein the heater component comprises steel comprising 99.18 to 99.62 wt % Iron, and the second wire comprises at least 99 wt % Tron.

6. A heater arrangement according to claim 1, wherein the first wire has a different composition to the heater component and the second wire.

7. A heater arrangement according to claim 6, wherein the first wire is made from a copper-nickel alloy.

8. A heater arrangement according to claim 1, further comprising:
a third wire connected to the heater component at a third position, wherein the third position is spaced apart from the first position and the second position;
wherein the electronic circuitry is further configured to:
determine a second temperature of the heater component at the third position based on a second potential difference measured between the third wire and the second wire.

9. A heater arrangement according to claim 8, wherein the third wire has a composition that is at least one of:
different to the composition of the heater component and the second wire; and
the same as the composition of the first wire.

10. A heater arrangement according to claim 9, wherein the first and third wires are made from a copper-nickel alloy.

11. A heater arrangement according to claim 8, wherein the first position is closer to a first end of the heater component than the second position, and the second position is closer to the first end of the heater component than the third position.

12. A heater arrangement according to claim 11, wherein the second position is located on the heater component at a midpoint between the first position and the third position.

13. A heater arrangement according to claim 1, wherein at least one of:
at the first position, where the first wire is connected to the heater component, the first wire is covered by a protective coating; and
at the second position, where the second wire is connected to the heater component, the second wire is covered by a protective coating.

14. A heater arrangement for an aerosol provision device, comprising:
a heater component arranged to heat aerosol generating material;
a first wire connected to the heater component at a first position;
wherein, at the first position, where the first wire is connected to the heater component, the first wire is covered by a protective coating.

15. A heater arrangement according to claim 13, wherein the protective coating comprises a metal or a metal alloy.

16. A heater arrangement according to claim 15, wherein the protective coating comprises nickel.

17. A heater arrangement according to claim 13, wherein the protective coating comprises a sealant.

18. An aerosol provision device, comprising:
a heater arrangement according to claim 1; and
an inductor coil for generating a varying magnetic field.

19. An aerosol provision system, comprising:
an aerosol provision device according to claim 18; and
an article comprising aerosol generating material.
